(19) United States
(12) Patent Application Publication
(10) Pub. No.: US 2012/0154427 A1
(43) Pub. Date: Jun. 21, 2012

(54) DIGITAL SIGNAGE APPARATUS, RECORDING MEDIUM, AND METHOD OF ADJUSTING DISPLAY FORMAT

(75) Inventor: Koichi SUGIYAMA, Osaka (JP)

(73) Assignee: SHARP KABUSHIKI KAISHA, Osaka (JP)

(21) Appl. No.: 13/315,431

(22) Filed: Dec. 9, 2011

(30) Foreign Application Priority Data
Dec. 15, 2010 (JP) 2010-279957

(51) Int. Cl. G09G 5/02

(52) U.S. Cl. 345/593

(57) ABSTRACT

A digital signage apparatus capable of enhancing an advertising effectiveness by improving the attractiveness and the attention value is provided. A digital signage apparatus (1) includes an image display unit (11) capable of displaying an image; an image signal processor (16) that adjusts a display format of a display area in the image display unit (11); and a CPU (13) that controls the image signal processor (16). The CPU (13) selects a red or blue color depending on illumination of outside light in a vicinity of the image display unit (11) and illumination of the display area in the image display unit (11), and controls the image signal processor (16) such that the selected color is displayed on a color display area which is at least a part of the display area.

### CROSS-REFERENCE TO RELATED APPLICATION

This application claims priority to Japanese Patent Application No. 2010-279957, which was filed on Dec. 15, 2010, the contents of which are incorporated herein by reference in its entirety.

### BACKGROUND OF THE TECHNOLOGY

1. Field of the Technology

The technology relates to a digital signage apparatus, a recording medium, and a method of adjusting a display format which are enhancing an advertising effectiveness.

2. Description of the Related Art

In recent years, a digital signage apparatus (electronic signboards) has been used as a tool for advertising to non-specific individuals in public places. The digital signage apparatus having an image display unit capable of displaying an advertising image prepared from a digital image can easily change advertising content. As a result, it is possible to provide viewers with up-to-date information and obtain an excellent advertising effectiveness in comparison with conventional advertising displays.

When a digital signage apparatus is used in an outdoor environment or the like where illumination of outside light is greatly changeable, visibility of the display image displayed on the image display unit changes greatly. In particular, when the digital signage apparatus is used in an environment where illumination of outside light is low, a Purkinje phenomenon may occur. That is, due to a variation of human luminosity characteristics, red color on the display image looks dark and dull, and blue color looks bright and vivid.

For example, Japanese Unexamined Patent Publication JP-A 2006-285063 proposes a technique for improving image quality and visibility by implementing an image signal processing and an illumination control of a backlight depending on surrounding illumination and image characteristics of an input image.

In addition, JP-A 2006-39520 proposes a technique of improving image quality, in which the backlight includes a white light source and a red light source, and control is performed such that the intensity of the white light source is lowered, and the red light source is turned on when the surrounding environment is dark.

The digital signage apparatus serves as a tool for advertisement by allowing the people surrounding the apparatus to view the advertising content displayed on an image display unit. Therefore, approaches have been contemplated in order to attract the interest or attention of the people surrounding the apparatus (improve attractiveness and attention value) by preventing any influence from illumination of the outside light so as to enhance an advertising effectiveness.

JP-A 2006-285063, and JP-A 2006-39520 described above disclose improvement of image quality and visibility of a display image displayed on an image display unit by processing an image signal and/or controlling a backlight depending on environmental illumination. However, an approach for the improvement of attractiveness and attention value depending on the luminance level of a display image and the change of luminosity characteristics, in addition to the environmental illumination has not been mentioned.

### SUMMARY OF THE TECHNOLOGY

An object of the technology is to provide a digital signage apparatus, a recording medium and a method for adjusting a display format which are capable of enhancing an advertising effectiveness by improving the attractiveness and the attention value.

The technology provides a digital signage apparatus including:

an image display unit capable of displaying an image;

a display format adjuster that displays an image on the image display unit in a predetermined display format; and

a controller that selects a color depending on brightness of outside light surrounding the image display unit and brightness of a display area on the image display unit and controls the display format adjuster such that an image is displayed on the image display unit in a predetermined display format depending on the color selected by the controller.

Furthermore, it is preferable that the display format adjuster forces the image display unit to display an image provided with a color display area for displaying the color selected by the controller, in a peripheral area of an original image to be displayed on the image display unit, and

the controller controls the display format adjuster such that the color selected by the controller is displayed on the color display area.

Furthermore, it is preferable that in a case where a text image is included in an original image to be displayed on the image display unit, the display format adjuster forces the image display unit to display an image provided with an area for applying one of an underline, a box, a highlight, and a shading, as a color display area for displaying the color selected by the controller in a peripheral area of the text image, and the controller controls the display format adjuster such that the color selected by the controller is displayed on the color display area.

Furthermore, it is preferable that in a case where display of one image on a display area is followed by display of another image, the display format adjuster forces the image display unit to display, the image obtained by using the color selected by the controller in an interval between the display of the one image and the display of the other image.

Furthermore, the technology provides a digital signage apparatus including:

an image display unit capable of displaying an image;

a light-emitting unit disposed in a vicinity of an image display area in an image display unit, the light-emitting unit having a light source capable of emitting light of a plurality of predetermined colors; and

a controller that selects a color depending on brightness of outside light in a vicinity of the image display unit and brightness of a display area in the image display unit and controls turn-on of the light source in the light-emitting unit such that light of the color selected by the controller is emitted.

Furthermore, it is preferable that the controller selects a blue color in a case where both brightness of outside light and brightness of the display area are darker than a predetermined brightness, and a red color in a case where brightness of outside light and/or brightness of display area are equal to or brighter than a predetermined brightness.

Furthermore, it is preferable that the digital signage apparatus further includes a spectral radiance sensor that measures spectral radiance,

the image display unit includes a display panel on which an image is to be displayed and a backlight that emits light from a back side in the display panel, and

the controller calculates illumination of the display area based on spectral radiance of light emitted from backlight which is measured by the spectral radiance sensor.

Furthermore, it is preferable that the controller calculates illumination of the display area based on spectral radiance of light emitted from the backlight which is measured by the spectral radiance sensor, spectral transmittance of members constituting the image display unit, and image information of an original image to be displayed on the image display unit.

Furthermore, it is preferable that the digital signage apparatus further includes an illumination sensor that measures illumination of light emitted from the predetermined area for measurement on the image display area,

for the measurement area, the controller obtains illumination of a display area using the illumination sensor by displaying an image corresponding to a maximum pixel value or average pixel value in an original image to be displayed.

The technology provides a non-transitory computer readable recording medium on which a program is recorded that causes a computer to execute the steps of:

determining whether or not brightness of outside light and brightness of a display area are darker than a predetermined brightness;

selecting a blue color when it is determined that both the brightness of outside light and the brightness of the display area are darker than the predetermined brightness, and selecting a red color when it is determined that brightness of outside light and/or brightness of the display area are equal to or brighter than the predetermined brightness; and

displaying an image in a predetermined display format depending on the selected color.

Furthermore, the technology provides a method of adjusting a display format including the steps of:

determining, by a controller, whether or not brightness of outside light and brightness of a display area, which are detected by a brightness detector, are darker than a predetermined brightness;

selecting, by the controller, a blue color when it is determined that both the brightness of outside light and the brightness of the display area are darker than the predetermined brightness, and selecting, by the controller, a red color when it is determined that brightness of outside light and/or brightness of the display area are equal to or brighter than the predetermined brightness; and

forcing, by a display format adjuster, an image display unit to display an image in a predetermined display format depending on the color selected by the controller.

The image display unit of the digital signage apparatus displays an image provided on a color display area for color display to attract the attention of people to the original advertising image, and the selected color in a color display area according to the Purkinje phenomenon, that is, if the surrounding environment of the digital signage apparatus is dark, the blue color, clearly seen in a dark place, is displayed, and if the surrounding environment is not dark, the red color is displayed. The color on a display area is displayed depending on the surrounding environment so that interest or attention of people for an advertising image displayed on the image display unit near the digital signage apparatus can be highly attracted. Accordingly, an advertising effectiveness can be enhanced by the degree to which the advertising image grabs attention, that is, the attractiveness and the attention value.

### BRIEF DESCRIPTION OF THE DRAWINGS

Other and further objects, features, and advantages of the technology will be more explicit from the following detailed description taken with reference to the drawings wherein:

FIG. 1 is a systematic diagram schematically illustrating a digital signage apparatus according to a first embodiment;

FIG. 2 is a cross-sectional view schematically illustrating a configuration of an image display unit constituting the digital signage apparatus;

FIG. 3 is a view illustrating exemplary locations of window portions for receiving measurement target light in the image display unit;

FIG. 4 is a block diagram illustrating a configuration of the digital signage apparatus;

FIGS. 5A and 5B are diagrams illustrating an example of a display format adjustment process performed in an image signal processor, wherein FIG. 5A illustrates an image obtained when image information received from an AD converter is displayed, and FIG. 5B illustrates an image obtained when image information after the adjustment process in the image signal processor is displayed;

FIGS. 6A to 6E are diagrams illustrating another example of a display format adjustment process performed in the image signal processor, wherein FIG. 6A illustrates an image obtained when image information received from the AD converter is displayed, and FIGS. 6B, 6C, 6D, and 6E illustrate an image obtained when image information after the adjustment process in the image signal processor is displayed;

FIG. 7 is a graph illustrating an example of spectral radiance of outside light received through one window portion;

FIG. 8 is a graph illustrating luminosity characteristics of a color-matching function;

FIG. 9 is a graph illustrating an example of spectral radiance of the backlight received through another window portion;

FIG. 10 is a graph illustrating an example of a spectral transmittance of a color filter of an LCD panel;

FIG. 11 is a graph illustrating a relative luminosity;

FIG. 12 is a flowchart illustrating a sequence of a display format adjustment process in the digital signage apparatus according to the first embodiment;

FIG. 13 is a diagram illustrating image insertion during image switching;

FIG. 14 is a block diagram illustrating a configuration of a digital signage apparatus according to a second embodiment;

FIG. 15 is a front view schematically illustrating a configuration of an image display unit of the digital signage apparatus;

FIG. 16 is a systematic diagram schematically illustrating a digital signage apparatus according to a third embodiment;

FIGS. 17A to FIG. 17C are diagrams illustrating an installation state of a first optical fiber to a window portion, wherein FIG. 17A is a perspective view schematically illustrating an image display unit having the first optical fiber, FIG. 17B is an enlarged bottom view illustrating a vicinity of an installation portion of the first optical fiber in FIG. 17A, and FIG. 17C is a enlarged front view illustrating the vicinity of the installation portion of the first optical fiber of FIG. 17A;

FIG. 18 is a block diagram illustrating a configuration of the digital signage apparatus;

FIG. 19 is a flowchart illustrating a sequence of a display format adjustment process in the digital signage apparatus according to the third embodiment.

FIG. 20 is a systematic diagram schematically illustrating the digital signage apparatus further including a sensor calibration unit; and

FIG. 21 is a perspective view schematically illustrating a configuration of the sensor calibration unit.

### DETAILED DESCRIPTION

Now referring to the drawings, preferred embodiments are described below.

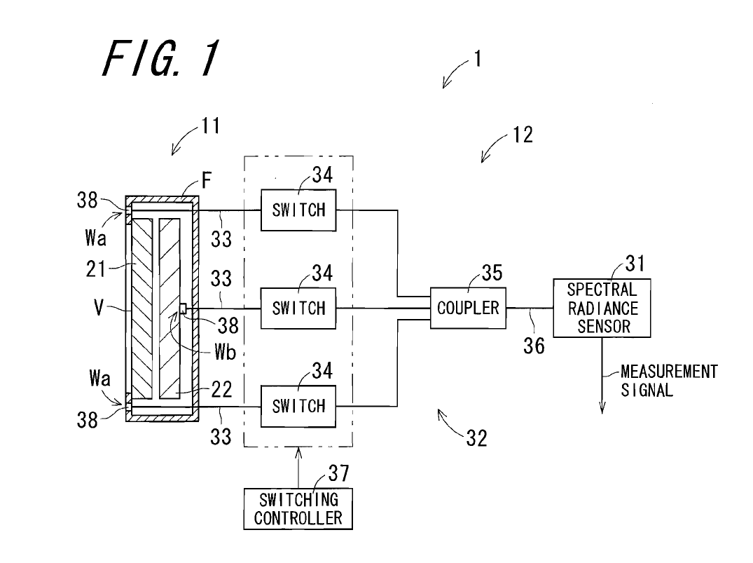

FIG. 1 is a systematic diagram schematically illustrating a digital signage apparatus 1 according to a first embodiment. The digital signage apparatus 1 has an image display unit 11 capable of displaying an advertising image constituted by a digital image, and a brightness detector 12.

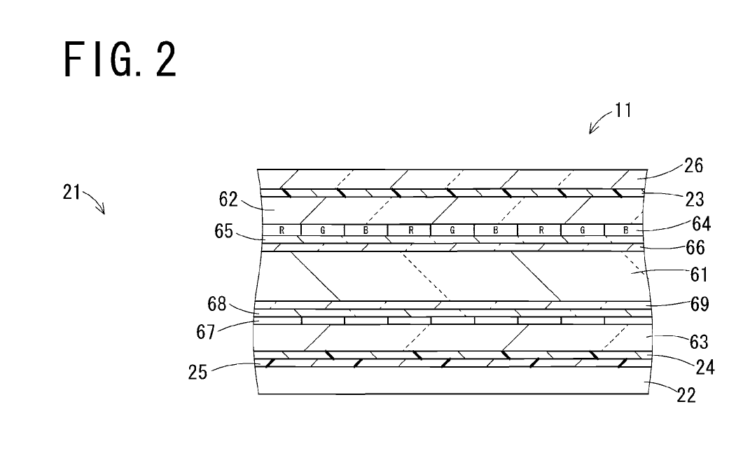

FIG. 2 is a cross-sectional diagram schematically illustrating a configuration of the image display unit 11 constituting the digital signage apparatus 1. According to the embodiment, the image display unit 11 is implemented by a liquid crystal display device having a liquid crystal display (LCD) panel 21 and a backlight 22. The image display unit 11 has, in addition to the LCD panel 21 and the backlight 22, polarizers 23 and 24, a diffuser 25, and a protective glass 26.

The LCD panel 21 has a liquid crystal layer 61, and first and second glass substrates 62 and 63. On one surface of the first glass substrate 62 in a thickness direction thereof, a color filter 64, a transparent electrode 65, and an alignment film 66 are formed. On one surface of the second glass substrate 63 in a thickness direction thereof, an alignment film 69 and a transparent electrode 68 forming pixels, and a thin-film transistor 67 connected thereto are formed.

The LCD panel 21 is configured by filling liquid crystals in a sealed manner between the first and second glass substrates 62 and 63 in a state where the alignment films 66 and 69 face each other to thereby form the liquid crystal layer 61.

The backlight 22 is disposed so as to face a back side of the LCD panel 21, namely a surface of the second glass substrate 63 on the other side in the thickness direction thereof (hereinafter referred to as a “light entrance surface”). The backlight 22 has a function of emitting light to the LCD module 21 from the back side thereof.

According to the embodiment, the backlight 22 is configured by planarly arranging a plurality of light emitting diode (LED) light sources along a surface direction of the light entrance surface of the second glass substrate 63. That is, the backlight 22 is configured as a direct type LED backlight. The backlight 22 is not limited to this configuration. For example, the backlight 22 may be configured as an edge-lit type LED backlight or be configured by arranging cold cathode tubes side by side.

The polarizer 23 is disposed on a surface of the first glass substrate 62 on the other side in the thickness direction thereof (hereinafter referred to as a “light exiting surface”), and the polarizer 24 is disposed on the light entrance surface of the second glass substrate 63. The polarizers 23 and 24 are provided so as to transmit linearly polarized lights that are perpendicular to each other.

The diffuser 25 is arranged between the backlight 22 and the polarizer 24 disposed on the light entrance surface of the second glass substrate 63. The diffuser 25 has a function of diffusing the light emitted from the backlight 22 in all directions. The protective glass 26 is disposed on the surface of the polarizer 23 on the opposite side to the side facing the first glass substrate 62. The protective glass 26 has a function of protecting the LCD panel 21.

With this configuration, a linearly polarized light having passed through the polarizer 24 among the light emitted from the backlight 22 enters the polarizer 23 through the liquid crystal layer 61. In this case, the polarization state of the light passing through the liquid crystal layer 61 can be changed by a voltage applied to the liquid crystal layer 61. Thus, by applying a voltage corresponding to an image signal between the transparent electrodes 65 and 68 on the first and second glass substrates 62 and 63 to thereby apply an electric field to the liquid crystal layer 61, it is possible to change the polarization state of the light passing through the liquid crystal layer 61 and to control the amount of the light passing through the polarizer 23 to thereby form an optical image.

In the embodiment, the backlight 22 of the image display unit 11 is capable of area active control. That is, lighting control of a plurality of LED light sources mounted on the backlight 22 can be performed on a block basis, for example, in the unit of one or more LED light sources.

Referring to FIG. 1 again, the brightness detector 12 is configured to detect brightness of outside (ambient) light in the environment of the digital signage apparatus 1 and brightness emitted from LED light source mounted on the backlight 22.

In the embodiment, the brightness detector 12 has a spectral radiance sensor 31 as a detector that detects brightness and measures spectral radiance of the light emitted from the LED light source mounted on the backlight 22.

As shown in FIG. 1, the brightness detector 12 includes, in addition to a single spectral radiance sensors 31, a plurality of window portions Wa for receiving outside light in an environment where the digital signage apparatus 1 is provided, a plurality of window portions Wb for receiving light emitted from LED light source mounted on the backlight 22, and an optical transmission unit 32 for transmitting light received through each window Wa and Wb such that the light received through each of the window portions Wa and Wb is individually inputted to a single spectral radiance sensor 31.

The spectral radiance sensor 31 measures spectral characteristics of the received light when the light received through each window portions Wa and Wb is transmitted by the optical transmission unit 32 and inputted thereto. Specifically, the spectral radiance sensor 31 measures spectral radiance (W/(sr·m²·nm)) for the received light at a predetermined wavelength interval within a predetermined wavelength range.

In the embodiment, the spectral radiance sensor 31 measures spectral radiance at a wavelength interval of 1 nm within a visible light wavelength range, that is, a wavelength range of 380 to 780 nm. When the spectral radiance sensor 31 measures spectral radiance of the received light, the measurement signal including the measurement result is outputted to a central processing unit (abbreviated as CPU) 13 which will be described below.

For example, the spectral radiance sensor 31 is configured by a polychromator-type spectral radiance meter using diffraction gratings or a filter-type luminance colorimeter. The polychromator-type spectral radiance meter condenses the measurement target light at the lens and splits the condensed light into the diffraction grating on a wavelength basis, the luminance for each wavelength is measured by a plurality of a photo sensors (for example, a photodiode array). In the filter-type luminance colorimeter, light is transmitted on a wavelength basis using a tunable filter or the like, and each luminance is measured using a photosensor. Since the spectral transmittance of the tunable filter and each wavelength control experience secular change, generally, measurement precision tends to degrade compared to the polychromator-type spectral radiance meter.

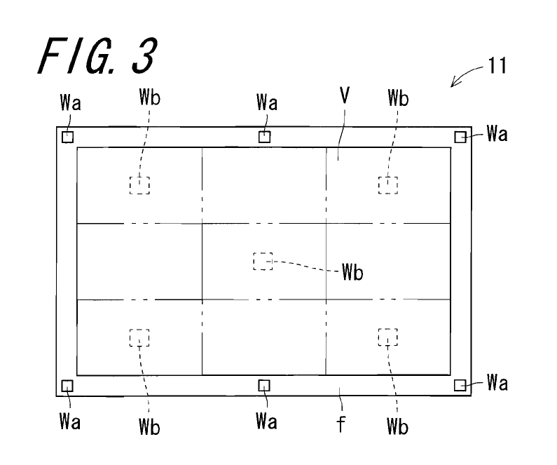

FIG. 3 is a diagram illustrating exemplary locations of the window portions Wa and Wb for receiving the measurement target light in the image display unit 11. FIG. 3 is a diagram illustrating the image display unit 11 of FIG. 1 as seen in a left-side view, that is, a diagram illustrating the image display unit 11 as seen from the side facing the image display area V (hereinafter, referred to as a “display area”).

As shown in FIG. 3, the window portion Wa for receiving outside light is provided in each area in the surface direction outer than the display area V. In the embodiment, six window portions Wa are provided in a bezel part f having a rectangular box shape at the front face of a frame F. Specifically, the window portions Wa are provided in four corners of the bezel part f and centers in longitudinal directions of a pair of long sides on the bezel part f, respectively. The LCD panel 21 and the backlight 22 are housed in the frame F.

Further, the window portion Wb for receiving the light emitted from the LED light source mounted on the backlight 22 is provided in the back side of the backlight 22. In the embodiment, the display area V is provided inside the rectangular area located at the center and the rectangular areas located in the four corners out of a total of nine rectangular areas obtained by equally dividing the display areas V in a matrix of 3×3 horizontally and vertically. Each window portion Wb is provided to receive the light emitted from the LED light source arranged side by side in the corresponding rectangular area.

The installation numbers and the installation locations of each of the window portion Wa and Wb may be appropriately changed without being limited to the example of FIG. 3. In the embodiment, measurement diffusers 38 are provided in the window portions Wa and Wb, respectively. That is, each of the window portions Wa and Wb is configured to receive the measurement target light through a measurement diffuser 38.

In this manner, by installing the measurement diffuser 38 in each of the window portions Wa and Wb, it is possible to prevent the intense light having entered each of the window portions Wa and Wb from directly entering the spectral radiance sensor 31 through the optical fibers 33 and 36 which will be described below. As a result, it is possible to prevent damage in the spectral radiance sensor 31 caused by the intense light. In addition, it is possible to prevent degradation of the measurement precision in the spectral radiance sensor 31 caused by various kinds of image formation.

In the embodiment, since the measurement diffuser 38 is installed in this manner, spectral transmittance of the measurement diffuser 38 (for example, visible light of 380 to 780 nm, 1 nm step size, and 401 values) is stored in a storage device (not shown), which will be described below, as a numerical value table in advance, and a substantial spectral radiance value is calculated by dividing a spectral radiance value measured by the spectral radiance sensor 31 (similarly, 401 values of visual light) by the spectral transmittance for a wavelength basis.

Referring to FIG. 1 again, the optical transmission unit 32 includes first optical fibers 33 provided in the window portions Wa and Wb, respectively, a second optical fiber 36 connected to the spectral radiance sensor 31, a coupler 35 connected between the first optical fibers 33 and the second optical fiber 36, switches 34 attached to the first optical fibers 33, and a switching controller 37 for controlling a switching operation in each switch 34.

Each first optical fiber 33 is provided such that one end thereof faces the measurement diffuser 38 provided in each of the window portions Wa and Wb, and the other end thereof is connected to the coupler 35, and the light received through the measurement diffuser 38 is guided to the coupler 35.

The second optical fiber 36 is provided such that one end thereof is connected to the coupler 35, and the other end thereof is connected to an input terminal of the spectral radiance sensor 31, so that light arriving at the first optical fiber 33 is guided to reach the spectral radiance sensor 31. The spectral radiance of the light guided to the spectral radiance sensor 31 is measured by the spectral radiance sensor 31.

The coupler 35 is configured to transmit the light guided through the first optical fiber 33 to the second optical fiber 36. For example, the coupler 35 is implemented using multiple branching optical fibers.

The switch 34 is configured to switch the optical transmission channel formed by a first optical fiber 33 between a permissible state at which light transmission is permitted and a cut-off state at which light transmission is cut off.

That is, when the switch 34 is in the permissible state, the first optical fiber 33 to which the switch 34 is attached can guide the light received through the window portions Wa and Wb to the coupler 35. Meanwhile, when the switch 34 is at the cut-off state, the first optical fiber 33 to which the switch 34 is attached can not guide the light received through the window portions Wa and Wb to the coupler 35. For example, the switch 34 can be implemented by an electronic shutter.

The switching controller 37 is configured such that the switching control signal for switching between the permissible state and the cut-off state is individually sent to the switch 34. Each switch 34 is configured to switch from the permissible state to the cut-off state or from the cut-off state to the permissible state based on the switching control signal sent from the switching controller 37.

The switching controller 37 sends the switching control signal such that each switch 34 sequentially has the permissible state in a predetermined order based on a switching control program stored in a storage device (not shown). For example, if the window portions Wa and Wb are arranged as shown in FIG. 3, the switching control signal is sent such that each switch 34 sequentially is in the permissible state in the order of the upper left window portion Wa, the upper center window portion Wa, the upper right window portion Wa, the lower left window portion Wa, the lower center window portion Wa, the lower right window portion Wa, the upper left window portion Wb, the upper right window portion Wb, the center window portion Wb, the lower left window portion Wb, and the lower right window portion Wb. Additionally, the switching controller 37 sends the switching control signal such that some of the switches 34 are not in the permissible state simultaneously.

That is, the entirety of the switches 34 can only be in one of the state in which all switches 34 are cut off and the state in which only one of the switches 34 is in the permissible state. As a result, it is possible to prevent the light received through different window portions Wa and Wb from entering the spectral radiance sensor 31 simultaneously.

As the switching controller 37 receives a brightness detection start command sent from the CPU 13 described below, the switching control signal is sent such that each of the switches 34 is in the permissible state in turn based on the switching control program as described above.

The CPU 13 is configured to send the brightness detection start command at every predetermined time interval. That is, the brightness detection process is executed at every predetermined time interval. This predetermined time interval may be set by a user, and is set to a time interval of, for example, 1 to 10 minutes.

In this configuration, in the brightness detection process executed at every predetermined time interval, the brightness detector 12 measures the spectral radiance of the light received through each of the window portions Wa and Wb in turn for each of the window portions Wa and Wb and sends a series of the measurement results as a measurement signal to the CPU 13.

In the embodiment, the brightness detector 12 sends, to the CPU 13, the measurement results of the spectral radiance of outside light received from six window portions Wa and the measurement results of spectral radiance of the backlight 22 received through five window portions Wb as a measurement signal.

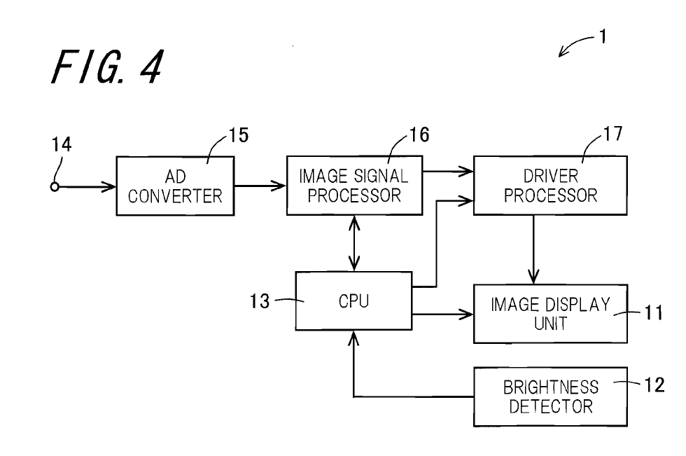

FIG. 4 is a block diagram illustrating a configuration of the digital signage apparatus 1. The digital signage apparatus 1 includes, in addition to the image display unit 11 and the brightness detector 12 shown in FIG. 1, the CPU 13, a storage devices such as a ROM (Read Only Memory), a RAM (Random Access Memory), a memory, or the like (not shown), an input terminal 14, an analog-digital (hereinafter, referred to as an “AD”) converter 15, an image signal processor 16, and a driver processor 17.

By executing the program stored in the storage device (not shown), the CPU 13 controls the image signal processor 16, the driver processor 17, and the image display unit 11. The aforementioned program is stored in the ROM and deployed in the RAM. The storage device includes a semiconductor memory and stores information used when the CPU 13 executes the program described above. The controller includes the CPU 13, the ROM, the RAM, and the storage device.

The input terminal 14 is a terminal where the advertising content image information sent from the external information processing apparatus or the advertising content image information stored in advance in the storage device (not shown) are inputted as an analog signal.

The AD converter 15 converts the image information of the analog signal inputted to the input terminal 14 from an analog signal to a digital signal and sends the image information of the converted digital signal to the image signal processor 16. Here, the image information sent from the input terminal 14 may be a digital signal. In this case, the AD converter 15 is not necessary.

The image signal processor 16 performs the image processing for the image information received from the AD converter 15 based on a command of the CPU 13. Specifically, in order to effectively attract interest or attention of people in surrounding the digital signage apparatus 1 to the advertising image displayed on the image display unit 11, the image display format of the image information received from the AD converter 15 is adjusted. The image signal processor 16 sends the image information subjected to the image processing to the driver processor 17. In the embodiment, the image signal processor 16 corresponds to a display format adjuster.

Hereinafter, a method of adjusting the display format performed by the image signal processor 16 will be described. A method of adjusting the display format according to the embodiment is performed by adding a color display area v, where a particular color can be given to an original advertising image to be displayed on the image display unit 11 based on the image information received from the AD converter 15 and assigning a color selected by the CPU 13 to the color display area v. Selection of the color using the CPU 13 will be described below.

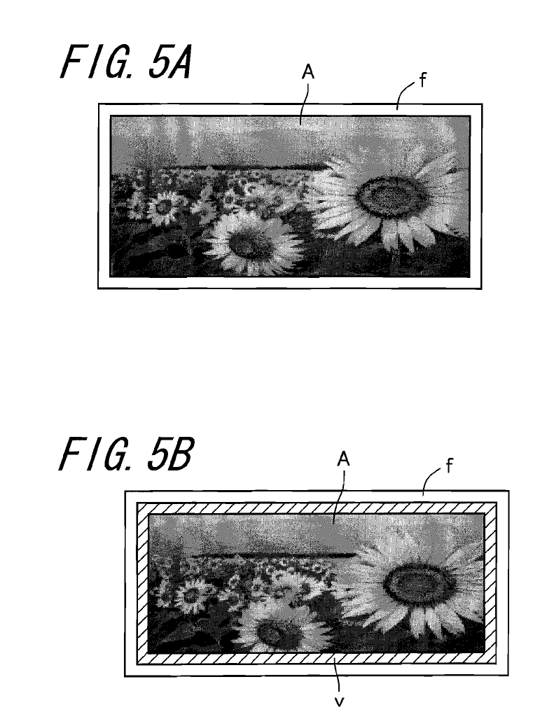

Various methods can be contemplated for a method of adding the color display area v to the original advertising image, and description thereof will be provided hereinafter. FIGS. 5A and 5B are diagrams illustrating an example of a display format adjustment process performed in the image signal processor 16. FIG. 5A illustrates an image obtained when the image information received from the AD converter 15 is displayed, and FIG. 5B illustrates an image obtained when the image information after the adjustment process in the image signal processor 16 is displayed.

As shown in FIG. 5A, if the image information received form the AD converter 15 is displayed as it is on the screen, an original advertising image A is displayed across the entire display area V. Meanwhile, as shown in FIG. 5B, if the image information subjected to the adjustment process according to the example is displayed on a screen, the color display area v having a rectangular box shape is added to a peripheral area of the display area V. The original image A cut by the amount of the color display area v is displayed inside the color display area v. In addition, the shape and size of the color display area v may be adequately set by a user. For example, a rectangular area which is adjacent to one edge side of the display area V may be set as the color display area v.

The display resolution and the display size of the original image A may be adjusted such that is can be received by the range obtained by subtracting the color display area v from the display area V. Alternatively, the substantial display resolution (for example, 1920×1080 dots) may be fixed, and an extra area for the color display area v having a width of several tens dots may be added to the peripheral area. Specifically, if the color display area v having a rectangular box shape is set to a width of 30 dots, the display area V has a size of 1980×1140 dots, and a substantial display resolution for the original image A can be obtained as a full high definition (FHD: 1920×1080 dots).

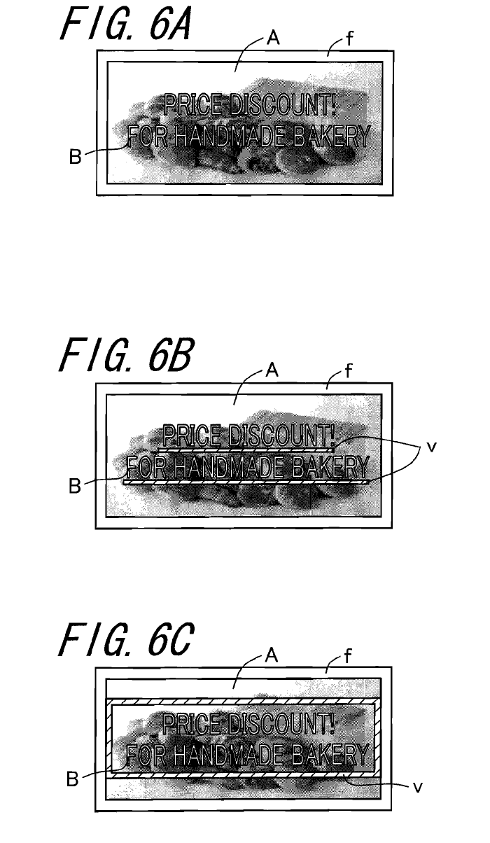

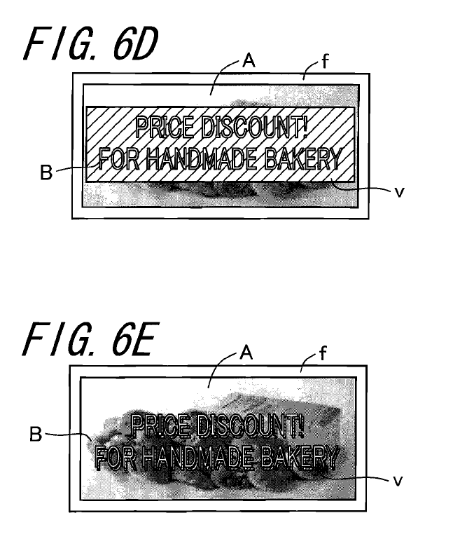

FIGS. 6A to 6E are diagrams illustrating another example of a display format adjustment process performed in the image signal processor 16. FIG. 6A illustrates an image obtained when the image information received from the AD converter 15 is displayed, and FIGS. 6B, 6C, 6D, and 6E illustrate an image obtained when the image information after the adjustment process in the image signal processor 16 is displayed.

The adjustment process according to the example is performed when the text information (character information) is included in the image information received from the AD converter 15 as shown in FIG. 6A. Specifically, if the image information and the text information can be distinguished, the adjustment process is executed to add the color display area v of highlighting the text image B near the text image B in the original advertising image A.

For example, as shown in FIG. 6B, the color display area v corresponding to an underline may be added to the text image B. As shown in FIG. 6C, the color display area corresponding to a box of the rectangular shape surrounding the text image B may be added to the text image B.

As shown in FIG. 6D, the color display area v corresponding to a highlight may be added to the text image B. As shown in FIG. 6E, the color display area v corresponding to a shading of the text image B may be added to the text image B.

The driver processor 17 converts the image information subjected to the image processing, received from the image signal processor 16, from the digital signal to the analog signal and sends the image information of the converted analog signal to the image display unit 11. In addition, the driver processor 17 performs control of the image display unit 11 such as RGB (red, green, and blue) drive control in the LCD panel 21 and luminance adjustment control for each LED light source of the backlight 22.

The brightness detector 12 executes a brightness detection process at every predetermined time interval as described above and sends the measurement signal including the measurement results corresponding to the window portions Wa and Wb to the CPU 13.

The CPU 13 calculates illumination of outside light and illumination of the display area V (hereinafter, referred to as a “panel surface”) in the image display unit 11 based on the measurement signal received from brightness detector 12.

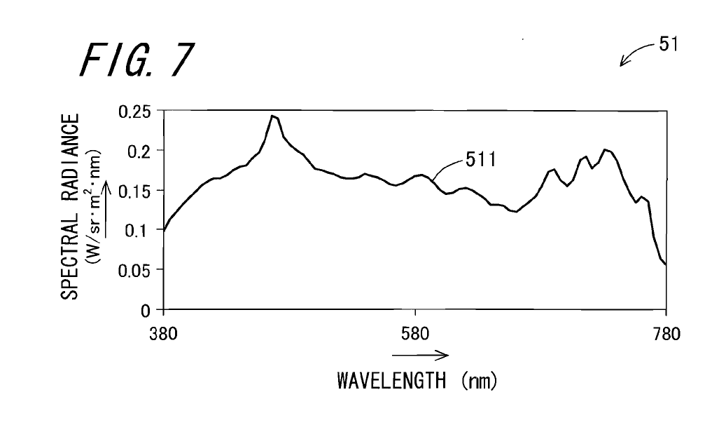

FIG. 7 is a graph 51 illustrating an example of spectral radiance of outside light received through the window portion Wa. In the graph 51, the ordinate denotes spectral radiance (W/(sr·m²·nm)), and the abscissa denotes wavelength (nm). The graph 51 illustrates spectral radiance 511 of outside light measured by the spectral radiance sensor 31 at every wavelength of 1 nm within a wavelength range between 380 nm and 780 nm.

Practically, it is preferable that the outside light is not directly inputted to the spectral radiance sensor 31 by transmitting through the aforementioned measurement diffuser 38 (that is, without exceeding the measurement range of the spectral radiance sensor 31). In this case aforementioned, since the spectral transmittance of the measurement diffuser 38 is measured in advance as described above and stored in the storage device as the known data, the actual measurement value of spectral radiance of outside light is obtained by dividing the spectral radiance 511 as the measurement result from the spectral radiance sensor 31 by the spectral transmittance of the measurement diffuser 38 on a wavelength basis.

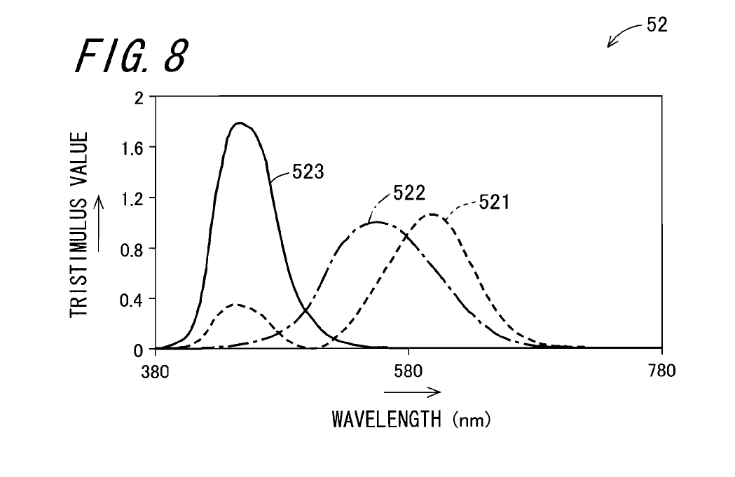

FIG. 8 is a graph 52 illustrating luminosity characteristics of the color-matching function. The ordinate denotes a tristimulus value, and the abscissa denotes a wavelength (nm). The color-matching function shown in FIG. 8 is a color-matching function of the XYZ color group, a color-matching function of the standard colorimetric observer defined in the standard CIE (Commission Internationale de I'Eclairage) 1931, and a function defined as luminosity characteristics with a 2° viewing angle.

The luminosity characteristic 521 of red light has two peaks including a convex shape, in which the tristimulus value becomes approximately 0.4 time the maximum in the vicinity of a wavelength of 430 nm in a wavelength range of about 400 to 500 nm, and a convex shape in which the tristimulus value becomes approximately 1.1 times the maximum in the vicinity of a wavelength of about 590 nm in a wavelength range of about 500 to 680 nm.

The luminosity characteristic 522 of the green light has a convex shape in which the tristimulus value becomes approximately 1.0 time the maximum in the vicinity of a wavelength of about 560 nm in a wavelength range of about 420 to 680 nm. The luminosity characteristic 523 of blue light has a convex shape in which the tristimulus value becomes approximately 1.8 times the maximum in the vicinity of a wavelength of about 450 nm in a wavelength range of about 380 to 550 nm. The luminosity characteristics of the color-matching function (not shown) are stored in advance in the storage device.

As the measurement result of the spectral radiance 511 of outside light shown in FIG. 7 is inputted through the measurement signal, the CPU 13 converts the measured spectral radiance 511 into XYZ values through a matrix operation (multiplication) with the color-matching function representing the luminosity characteristics shown in FIG. 8, read from the storage device, and extracts the Y value (cd/m²) from among them. As a result, the luminance (cd/m²) of outside light is obtained from the measured spectral radiance (W/(sr·m²·nm)) of outside light.

As the Y value of the luminance of outside light is calculated as described above, the CPU 13 converts the luminance (cd/m²) of outside light into illumination of outside light (lx) using the conversion method which will be described below.

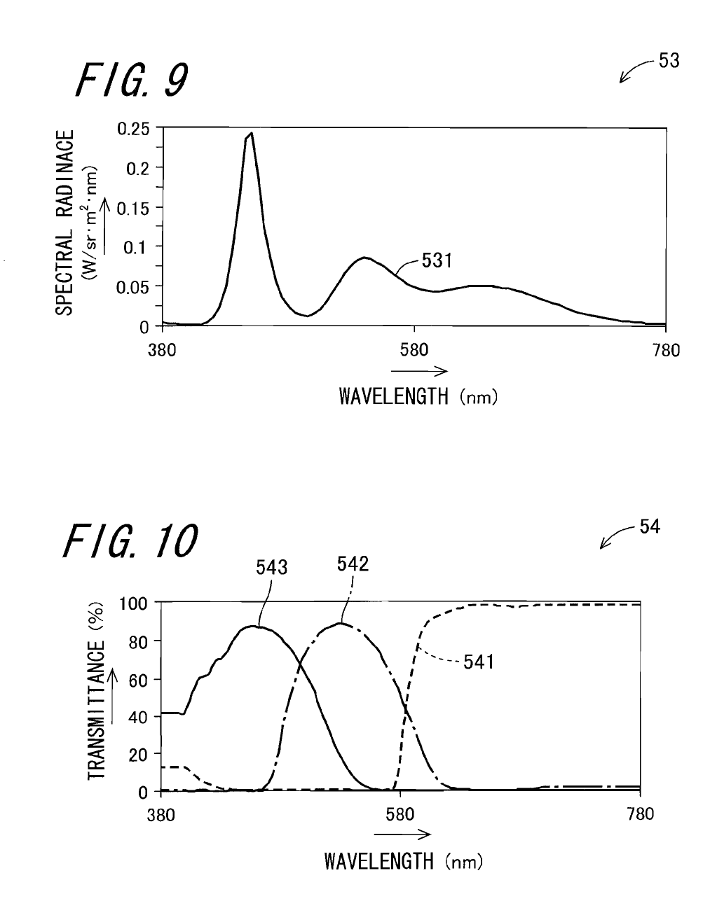

FIG. 9 is a graph 53 illustrating an example of the spectral radiance of the backlight 22 received through the window portion Wb. In the graph 53, the ordinate denotes the spectral radiance (W/(sr·m²·nm)), and the abscissa denotes the wavelength (nm). The graph 53 illustrates the spectral radiance 531 of the backlight 22 measured by the spectral radiance sensor 31 at every wavelength of 1 nm in the wavelength range of 380 nm to 780 nm.

Similar to the description of FIG. 7, in practice, it is preferable that the light of the backlight 22 is not directly inputted to the spectral radiance sensor 31 (that is, in order not to exceed the measurement range of the spectral radiance sensor 31) by transmitting through the aforementioned measurement diffuser 38.

FIG. 10 is a graph 54 illustrating an example of the spectral transmittance of the color filter 64 of the LCD panel 21. In the graph 54, the ordinate denotes transmittance, and the abscissa denotes a wavelength (nm). The graph 54 indicates, as transmittivy (%), luminance of each color obtained by splitting white light transmitting through the color filter 64 into three colors including red, green, and blue colors of the RGB system at every wavelength of 1 nm in a wavelength range of 380 to 780 nm by assuming that the luminance of white light irradiated to the color filter 64 is set to 100%.

The spectral transmittance 541 is transmittance of red light. The spectral transmittance 542 is transmittance of the green light. The spectral transmittance 543 is transmittance of blue light. The spectral transmittance of the color filter 64 of LCD panel 21 is measured by a dedicated measurement apparatus in advance before the color filter 64 is assembled with the apparatus. The spectral transmittance of the color filter 64 as the measurement result is stored in the storage device (not shown) before factory shipment.

When the measurement result of the spectral radiance 531 of the backlight 22 illustrated in FIG. 9 is inputted by the measurement signal, the CPU 13 calculates the spectral radiance of each component R, G, and B by multiplying the spectral transmittance 541 to 543 of each component R, G, and B of the color filter 64, illustrated in FIG. 10, read from the storage device by the measured spectral radiance 531 on a wavelength basis.

For the spectral radiance of each component R, G, and B, a matrix operation (multiplication) with the color-matching function and a conversion to the XYZ values are performed as described above. As a result, a conversion matrix of 3 rows by 3 columns from RGB values to XYZ values is calculated, and thus, it is possible to convert the RGB values of the image displayed in practice to the XYZ values. Strictly to say, considering gamma (for example, γ=2.2) of the monitor and gray scales (for example, 255 gray scales if the image information is represent as 8 bits), it is preferable that RGB values are set to R′=(R/255)̂γ, G′=(G/255)̂γ, and B′=(B/255)̂γ, and then, the R′G′B′ values be converted to XYZ values.

The Y value (cd/m²) is calculated by multiplying an average pixel value (RGB values) of the rectangular area corresponding to the window portion Wb by the spectral radiance, performing gamma and gray-scale correction, and performing conversion to XYZ values. As a result, the luminance of LCD panel 21 (hereinafter, referred to “panel surface luminance”, unit: cd/m²) is obtained from the spectral radiance (W/(sr·m²·nm)) of the backlight 22.

In the embodiment, since the panel surface luminance is obtained, only the spectral transmittance of the color filter 64 is considered. However, more accurate panel surface luminance can be obtained by considering the spectral transmittance of polarizers 23 and 24 and the liquid crystal layer 61.

If the aforementioned panel surface luminance is calculated as described above, the CPU 13 converts the panel surface luminance (cd/m²) to illumination (unit: lx (lux)) of the panel surface V using the following conversion method.

In case of the dot light source, a conversion formula of 1 (cd/m²)=4π (lx) is valid (unit of π is set to sr (steradian)). Meanwhile, in case of the plane light source, since it is assumed that there is no irradiation onto the rear surface (that is, the irradiation angle is hemisphere), the conversion formula of 1 (cd/m²)=2π (lx) is valid. However, in practice, it is necessary to consider decay along a distance from the light source and a half angle of the luminance. In this regard, if it is assumed that the half-power angle is set to 180°, and a decay rate when the distance from the light source surface is 1 m is 95%, a conversion formula of 1 (cd/m²)=2π×a×b (lx) is obtained. Here, assuming that illumination of 60% is obtained on average, and a=0.6 is given, since the decay rate is 95%, b=0.05 is given. As a result, it is contemplated that a conversion formula of 1 (cd/m²)=0.06π (lx) is obtained.

If the illumination of outside light of each window portion Wa is calculated from the measurement signal sent from the brightness detector 12 using the aforementioned calculation method, the CPU 13 calculates an average value of each calculated illumination of outside light (hereinafter, referred to as “average illumination of outside light”).

Similarly, if the illumination of the panel surface V of each window portion Wb is calculated from the measurement signal sent from the brightness detector 12, the CPU 13 calculates an average value from the calculated illumination of each panel surface V (hereinafter, referred to as “average illumination of the panel surface).

If the average illumination (lx) of outside light and the average illumination (lx) of the panel surface V are calculated, the CPU 13 selects a color used in the aforementioned adjustment process, that is, a color given to the color display area v based on these values.

Specifically, if the average illumination of outside light is lower than predetermined illumination, and average illumination of the panel surface V is lower than the aforementioned predetermined illumination, a blue group color is selected. Meanwhile, the average illumination of outside light is equal to or higher than the predetermined illumination, or the average illumination of the panel surface V is equal to or higher than the predetermined illumination, a red group color is selected. Here, the aforementioned predetermined illumination is set to illumination where a color perception variation occurs due to the Purkinje phenomenon. Preferably, the predetermined illumination is generally set to about 10 lx.

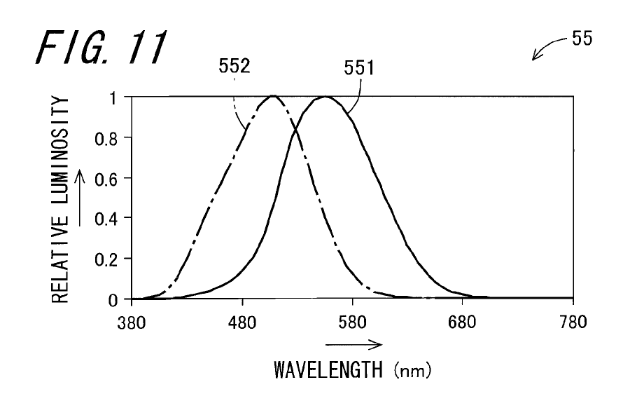

FIG. 11 is a graph 55 illustrating a relative luminosity. The ordinate denotes relative luminosity, and the abscissa denotes a wavelength (nm). FIG. 11 shows the luminosity characteristic 551 of photopic vision defined in the standard CIE1924 and the luminosity characteristic 552 of scotopic vision defined in the standard CIE1951.

In the Purkinje phenomenon, since a rod, which is a visual cell principally working in the scotopic vision generally equal to or smaller than 10 lx, responds well to contrasting, but it does not respond to long-wavelength light, red looks dark, and blue looks bright in the scotopic vision generally equal to or smaller than 10 lx. This phenomenon occurs because the peak wavelength of the relative luminosity moves to the short wavelength side of about 507 nm from the peak wavelength (555 nm) of the relative luminosity in the photopic vision as shown in FIG. 11. Therefore, as described above, it is preferable that the predetermined illumination is set to 10 lx.

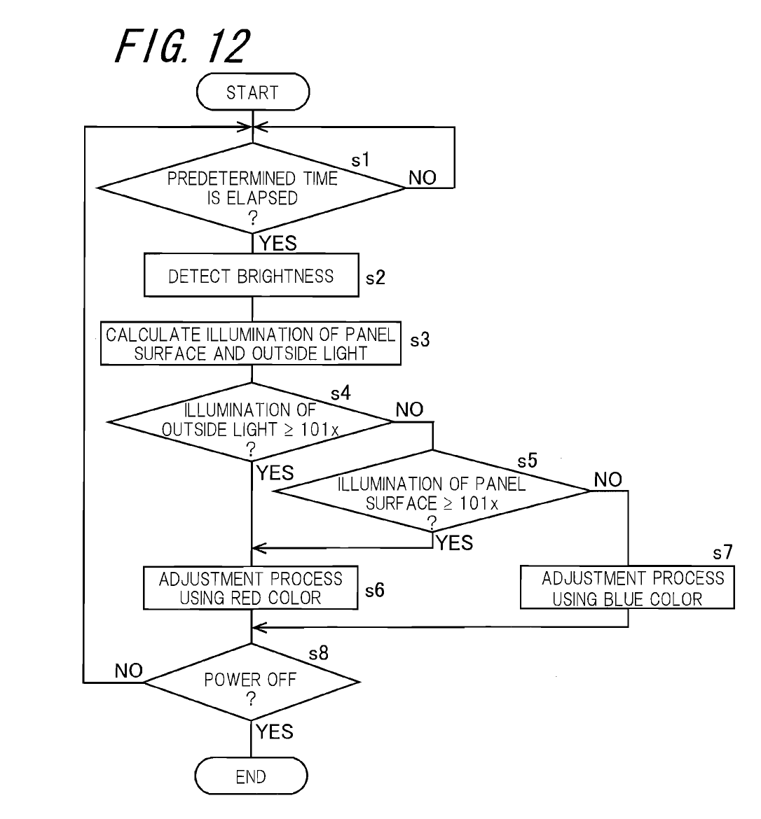

FIG. 12 is a flowchart illustrating a sequence of a display format adjustment process in digital signage apparatus 1 according to the first embodiment. The digital signage apparatus 1 is in an operable state as power is turned on. As a result, the image display unit 11 displays an image based on the image information subjected to image processing in the image signal processor 16.

If the digital signage apparatus 1 is in an operable state as described above, the CPU 13 initiates the display format adjustment process, and the process proceeds to step s1. In step s1, the CPU 13 determines whether or not a predetermined time is elapsed. If the CPU 13 determines that a predetermined time is elapsed, the process proceeds to step s2.

In step s2, the CPU 13 sends a brightness detection start command to the switching controller 37. As a result, in the brightness detector 12, the spectral radiance of the light received through each window portion Wa and Wb is measured by the spectral radiance sensor 31 for each window portion Wa and Wb in turn.

In step s3, the CPU 13 reads the luminosity characteristics of the color-matching function and the spectral transmittance of the color filter 64 from the storage device (not shown) and calculates illumination of outside light and illumination of the panel surface V based on the read information, the measurement signal sent from the brightness detector 12, and the pixel value of the image information of a single frame inputted to the image signal processor 16. In the embodiment, the average illumination of outside light and the average illumination of the panel surface V are calculated.

In the step s4, the CPU 13 determines whether or not the average illumination of outside light calculated in step s3 is equal to or higher than predetermined illumination. In the embodiment, the predetermined illumination is set to 10 lx. If it is determined that the average illumination of outside light is equal to or higher than 10 lx, the process proceeds to step s6. If it is determined that the average illumination of outside light is lower than 10 lx, the process proceeds to step s5.

In step s5, the CPU 13 determines whether or not the average illumination of the panel surface V calculated in step s3 is equal to or higher than predetermined illumination. In the embodiment, the predetermined illumination is set to 10 lx as described above. If it is determined that the average illumination of the panel surface V is equal to or higher then 10 lx, the process proceeds to step s6. If it is determined that average illumination of the panel surface V is lower than 10 lx, the process proceeds to step s7.

In step s6, the CPU 13 sends an execution command for the adjustment process as shown in FIGS. 5B and 6B to 6E, to the image signal processor 16. At this moment, the CPU 13 assigns a red color (red group color) to the color display area v added by the adjustment process. As a result, the image display unit 11 displays an image obtained by adding a red color display area v to the original advertising image to be displayed on the on the image display unit 11.

In step s7, the CPU 13 sends an execution command for the adjustment process as shown in FIGS. 5B and 6B to 6E, to the image signal processor 16. At this moment, the CPU 13 assigns a blue color (blue group color) to the color display area v added by the adjustment process. As a result, the image display unit 11 displays an image obtained by adding the blue color display area v to the original advertising image to be displayed on the image display unit 11.

In step s8, the CPU 13 determines whether or not power of the digital signage apparatus 1 is turned off. If it is determined that power is turned off, the CPU 13 terminates the display format adjustment process. If it is determined that power is not turned off, that is, is turned on, the CPU 13 returns the process to step s1.

As described above, according to the embodiment, an image obtained by adding the color display area v for displaying colors for attracting attention of people to the original advertising image is displayed on the image display unit 11 of the digital signage apparatus 1. In the color display area v, a color selected by considering the Purkinje phenomenon is displayed. That is, if the surrounding environment of the digital signage apparatus 1 is dark, a blue color which looks bright in a dark place is displayed. If the surrounding environment of the digital signage apparatus 1 is not dark, a red color is displayed.

In this manner, since a different color is displayed on the color display area v depending on surrounding environment, interests or attention of people who surround the digital signage apparatus 1 can be effectively attracted to the advertising image displayed on the image display unit 11. As a result, it is possible to enhance the advertising effectiveness by improving the attention-grabbing of the advertising image, that is, the attractiveness and the attention value.

Further, according to the embodiment, since the color displayed on the color display area v is selected considering illumination of outside light and illumination of the panel surface V, it is possible to effectively attract attention of people. According to the embodiment, since it is possible to improve the attractiveness and the attention value without modifying contents of the original advertising image to be displayed on the image display unit 11, it is possible to provide excellent convenience at the practical use.

Furthermore, according to the embodiment, since illumination of the panel surface V is calculated based on the spectral radiance of the backlight 22, it is possible to measure the spectral radiance of the backlight 22 on each area (particularly, the center area of the panel surface V) obtained by equally dividing the panel surface V without blocking the image display in the image display unit 11.

Furthermore, according to the embodiment, the spectral radiance of the light received from each window portion Wa and Wb is measured by a single spectral radiance sensor 31. As a result, it is possible to reduce cost in the entire digital signage apparatus 1 in comparison with a case where the spectral radiance sensor 31 is provided in each window portion Wa and Wb. In addition, since it is not necessary to consider a difference of each spectral radiance sensor 31, it is possible to measure the spectral radiance of outside light and the backlight 22 with high precision.

In a case where the spectral radiance sensor 31 is provided in each window portion Wa and Wb, an individual difference of each sensor, operational delay caused by sensing, A/D (analog/digital) conversion, and the like occurs. However, since the measurement is performed using a single spectral radiance sensor 31, it is possible to eliminate the individual difference and suppress operational delay and control delay.

In the first embodiment, the average illumination of outside light is calculated based on the illumination of outside light calculated for each window portion Wa, and the average illumination of the panel surface V is calculated based on illumination of the panel surface V calculated for each window portion Wb.

In contrast, as another embodiment, the color of the color display area v may be selected for each area of the panel surface V by individually considering illumination of outside light calculated for each window portion Wa and illumination of the panel surface V calculated for each window portion Wb.

For example, assuming that a large-sized digital signage apparatus 1 having a size of the panel surface V greater than 60 inches is used, if illumination of a left half area of the panel surface V and illumination of its surrounding outside light are lower than 10 lx, and illumination of a right half area of the panel surface V and illumination of its surrounding outside light are equal to or higher than 10 lx, a blue color may be selected for the left half of the panel surface V in the color display area v, and red color may be selected for the right half of the panel surface V. In this manner, it is possible to more effectively attract attention of people by selecting the color of the color display area v for each area of the panel surface V. In this case, a gradation from red to blue may be added to the color display area v.

In the first embodiment described above, the color display area v capable of assigning a color for attracting attention of people who surround the digital signage apparatus 1 to the original advertising image to be displayed on the image display unit 11 is added to the image signal processor 16.

In contrast, as another embodiment, when display of one advertising content image is followed by display of another advertising content image, an image of a color selected based on illumination of outside light and illumination of the panel surface V may be inserted in an interval between display of both images.

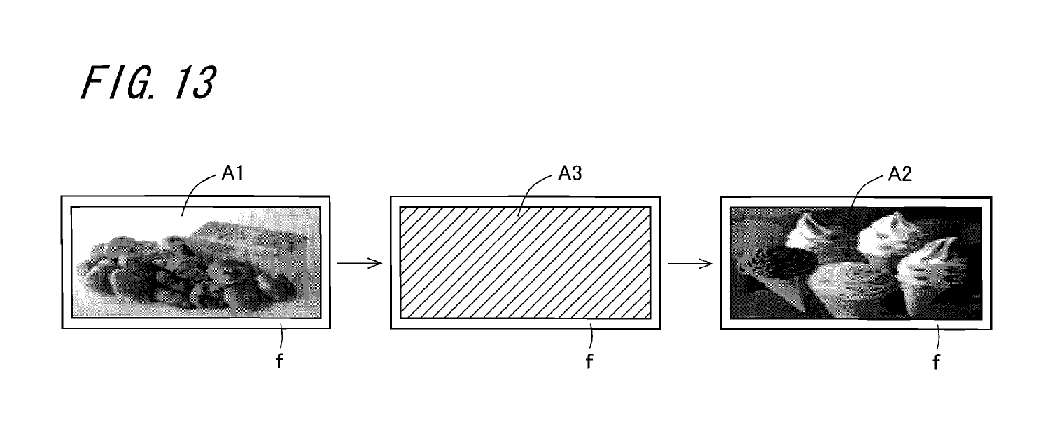

FIG. 13 is a diagram illustrating image insertion during image switching. FIG. 13 illustrates a flow of image display in a case where an insertion image A3 is inserted in an interval between display of original images A1 and A2 when display of the original advertising image A1 is followed by display of the original advertising image A2. By using an image of the color selected based on illumination of outside light and illumination of the panel surface V in the insertion image A3 shown in FIG. 13, it is possible to obtain the same effect at that of the first embodiment described above. Similarly, in the embodiment, the image signal processor 16 also corresponds to the display format adjuster.

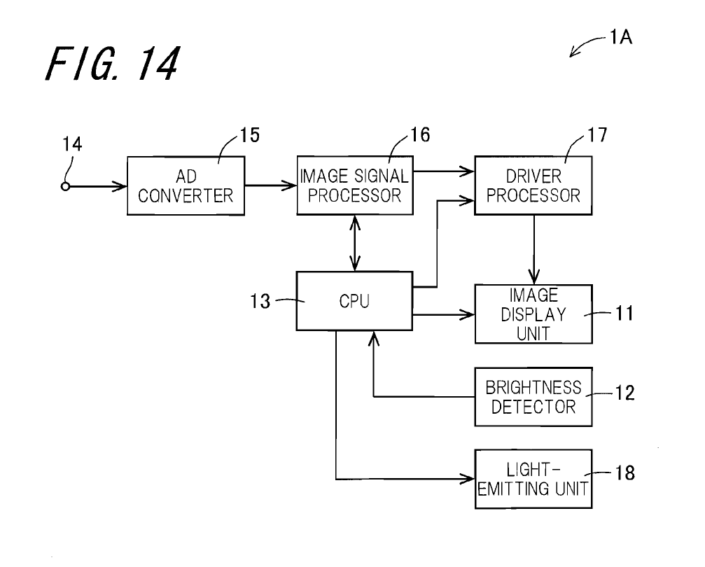

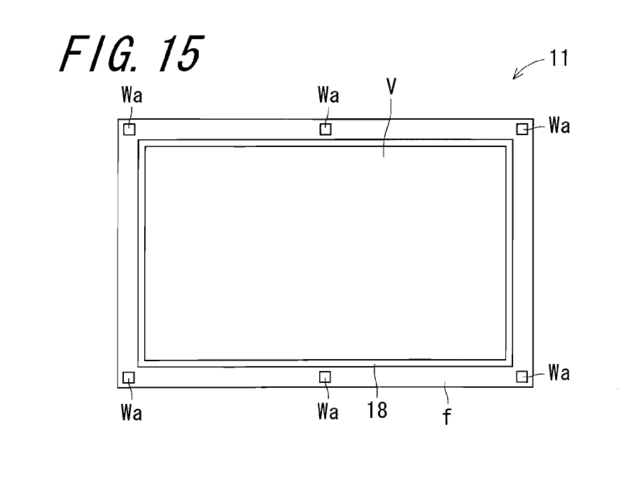

FIG. 14 is a block diagram illustrating a configuration of a digital signage apparatus 1A according to a second embodiment. FIG. 15 is a front view schematically illustrating a configuration of an image display unit 11 of the digital signage apparatus 1A.

The digital signage apparatus 1A includes an image display unit 11, a brightness detector 12, a CPU 13, a storage device such as a ROM and a RAM (not shown), an input terminal 14, an AD converter 15, an image signal processor 16, a driver processor 17, and a light-emitting unit 18.

As shown in FIG. 14, the digital signage apparatus 1A according to the embodiment is different from the digital signage apparatus 1 according to the first embodiment in that the light-emitting unit 18 is further disposed. Other components of the digital signage apparatus 1A are similar to those of the digital signage apparatus 1. Like elements as in the digital signage apparatus 1 are denoted by the same reference numerals, and description thereof will not be repeated.

The light-emitting unit 18 includes a plurality of light sources capable of emitting each of red light and blue light. The light source is disposed on the periphery of the display area V so as to emit light toward the front side of the display area V. The light-emitting unit 18 is configured to turn on or off each light source based on the control signal outputted from the CPU 13.

For example, the light-emitting unit 18 is configured by arranging a plurality of red LEDs and blue LEDs with a reasonable interval to surroundingly enclose the display area V. In the embodiment, the light-emitting unit 18 is configured by alternately arranging the red LEDs and the blue LEDs.

In this manner, in the embodiment, light having a predetermined color is emitted by turning on the light source in the light-emitting unit 18. That is, in the digital signage apparatus 1 according to the first embodiment, color display for attracting attention of people is performed by carrying out the display format adjustment process for the image information inputted to the image signal processor 16. On the other hand, in the digital signage apparatus 1A according to the embodiment, color display for attracting attention of people is performed by on/off control of the light-emitting unit 18 without carrying out the display format adjustment process for the image information inputted to the image signal processor 16. In this manner, the digital signage apparatus 1A according to the embodiment is provided with a hardware configuration for performing color display unlike the digital signage apparatus 1.

In the color display process in the digital signage apparatus 1A, if the average illumination of outside light and average illumination of the panel surface V are calculated by the CPU 13, the CPU 13 compares the calculated average illumination with predetermined illumination (101x). If the average illumination of outside light and the average illumination of the panel surface V are lower than 10 lx, the CPU sends a control signal for lighting the blue LED to the light-emitting unit 18. If the average illumination of outside light or the average luminance of the panel surface V is equal to or higher than 10 lx, the CPU 13 sends a control signal for lighting the red LED to the light-emitting unit 18.

As a result, the light-emitting unit 18 emits the color selected by considering the Purkinje phenomenon. That is, blue color which looks bright in a dark place is emitted if the surrounding environment of the digital signage apparatus 1A is dark. Otherwise, if the surrounding environment is not dark, red color is emitted.

In this manner, since the light-emitting unit 18 emits the light color depending on the surrounding environment, the advertising image displayed on the image display unit 11 can effectively attract interests or attention of people who surround the digital signage apparatus 1A. As a result, it is possible to enhance the advertising effectiveness by improving attention-grabbing of the advertising image, that is, the attractiveness and the attention value.

Furthermore, since the digital signage apparatus 1A according to the embodiment is not necessary to process the image information of the original advertising image to be displayed on the image display unit 11, it can be conveniently realized by mounting the light-emitting unit 18 on the existing digital signage apparatus.

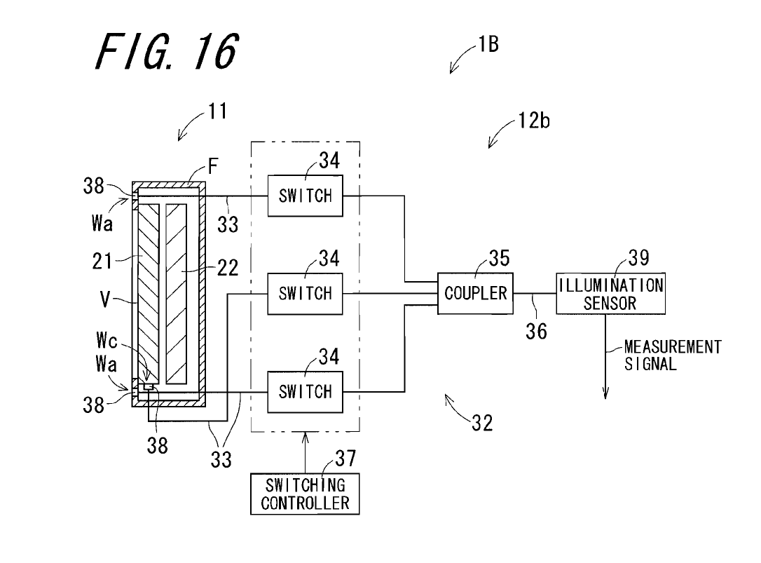

FIG. 16 is a systematic diagram schematically illustrating a digital signage apparatus 1B according to a third embodiment. The digital signage apparatus 1B has an image display unit 11 and a brightness detector 12b.

As shown in FIG. 16, a configuration of the brightness detector 12b of the digital signage apparatus 1B according to the embodiment is different from that of the brightness detector 12 of the digital signage apparatus 1 according to the first embodiment. Other components of the digital signage apparatus 1B are similar to those of the digital signage apparatus 1. Like elements as in the digital signage apparatus 1 are denoted by the same reference numerals, and description thereof will not be repeated.

The brightness detector 12b is configured to detect the brightness of outside light at the installation environment of the digital signage apparatus 1B and the brightness of light emitted from a predetermined measurement area V1 which is a part of display area V.

In the embodiment, the brightness detector 12b includes an illumination sensor 39 as a detector for detecting brightness and measures illumination of outside light and illumination of the light emitted from the predetermined measurement area V1.

In the measurement area V1, displayed is an image created based on illumination measurement image information generated based on the advertising content image information, not based on the advertising content image information. That is, the illumination sensor 39 measures illumination of the light emitted from the measurement area V1 based on the illumination measurement image information. The illumination measurement image information will be described below.

In this manner, an image different from the advertising image is displayed in the measurement area V1. Therefore, it is preferable that the measurement area V1 is disposed at a location not possibly affecting the advertising image displayed on the display area V. In the embodiment, the measurement area V1 is disposed in a corner portion on the lower right of the display area V.

Further, it is preferable that the area size of the measurement area V1 is set to one to several dots of pixels to reduce an effect on the advertising image displayed on the display area V. In the embodiment, the area size of the measurement area V1 is set to one dot of pixel having sub-pixels (picture elements) of R, G, and B.

As shown in FIG. 16, the brightness detector 12b includes a single illumination sensor 39 as well as a plurality of window portions Wa for receiving outside light at the installation environment of the digital signage apparatus 1B, a single window portion Wc for receiving the light emitted from the measurement area V1 described above, and an optical transmission unit 32 for transmitting the light received through each window portion Wa and Wc such that the light received through each window portion Wa and Wc is individually inputted to a single illumination sensor 39.

When the measurement target light received through each window portion Wa and Wc is transmitted by the transmission unit 39 and inputted to the illumination sensor 39, the illumination sensor 39 measures illumination (unit: lx) of the input light. When the illumination sensor 39 measures illumination of the input light, the measurement signal including the measurement result thereof is output to the CPU 13.

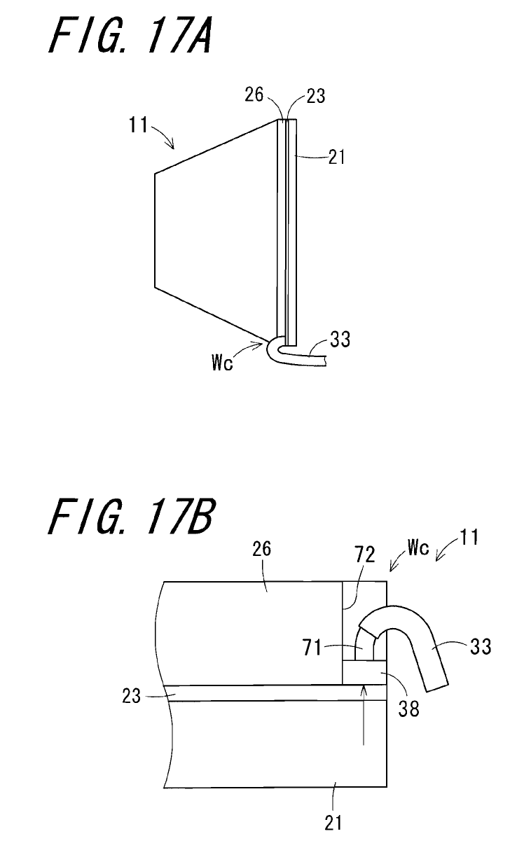

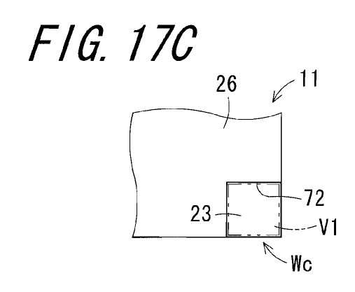

FIGS. 17A to FIG. 17C are diagrams illustrating an installation state of the first optical fiber 33 to the window portion Wc. FIG. 17A is a perspective view schematically illustrating the image display unit 11 having the first optical fiber 33. FIG. 17B is an enlarged bottom view illustrating the vicinity of the installation portion of the first optical fiber 33 in FIG. 17A.

FIG. 17C is an enlarged front view illustrating the vicinity of the installation portion of the first optical fiber 33 of FIG. 17A. In FIGS. 17A and 17B, the image display unit 11 is illustrated while the backlight 22, the polarizer 24, and the diffuser 25 are omitted. In FIG. 17C, the first optical fiber 33 is omitted.

As shown in FIG. 17A, the image display unit 11 is provided with the window portion Wc at the location corresponding to the aforementioned measurement area V1. As shown in FIG. 17C, the window portion Wc is provided by forming a notch 72 on the protective glass 26 such that a portion of the polarizer 23 corresponding to the measurement area V1 is externally exposed. As shown in FIG. 17B, the measurement diffuser 38 is attached to the window portion Wc.

Meanwhile, in the first optical fiber 33 for guiding the light emitted from the measurement area V1, a fiber terminal 71 is provided in one end thereof, and a light input port capable of inputting light is provided in the leading edge of the fiber terminal 71.

The first optical fibers 33 is provided in space where one end thereof is formed by the notch 72 such that the polarizer 23 exposed externally through the measurement diffuser 38 provided in the window portion We faces the light input port of the fiber terminal 71. The first optical fiber 33 is fixed using the methods such as adhesion.

In the embodiment, the polarizer 23 is externally exposed. The embodiment is not limited thereto, but the color filter 64 may be externally exposed. Further, in the embodiment, the rectangular notch 72 is formed in the protective glass 26 in order to provide one end of the first optical fiber 33. The embodiment is not limited thereto. For example, the through-hole may be formed in the protective glass 26.

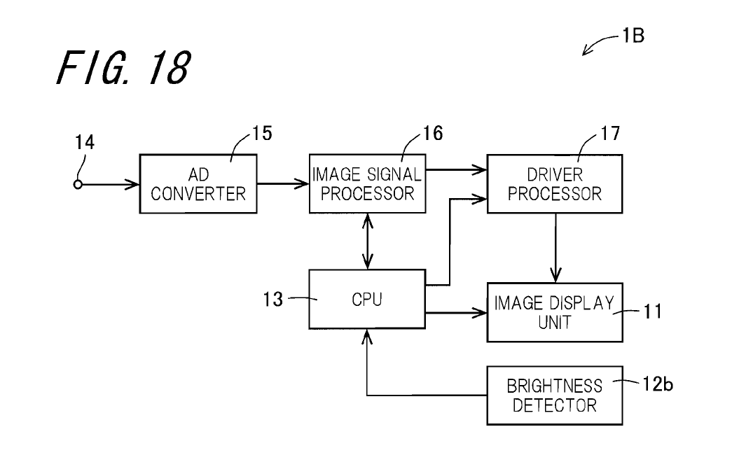

FIG. 18 is a block diagram illustrating a configuration of the digital signage apparatus 1B. The digital signage apparatus 1B includes a CPU 13, a storage device such as a ROM and a RAM (not shown), an input terminal 14, an AD converter 15, an image signal processor 16 and a driver processor 17 in addition to the image display unit 11 and the brightness detector 12b shown in FIG. 16.

In the embodiment, the CPU 13 creates the illumination measurement image information based on the advertising content image information inputted to the image signal processor 16. Here, the illumination measurement image information refers to image information for displaying the image corresponding to the maximum pixel value (luminance value) in the advertising content image information, or image information for displaying the image corresponding to an average pixel value (luminance value) in the advertising content image information.

Here, the illumination measurement image information may be created based on the maximum pixel value or the average pixel value in the entire image information of a single frame. Alternatively, the image information of a single frame may be divided into a plurality of areas, and the illumination measurement image information may be created based on the maximum pixel value or the average pixel value in each divided area. In this manner, when the image information of a single frame is divided into a plurality of areas, the images corresponding to the maximum pixel value or the average pixel value of each divided area are sequentially displayed on the measurement area V1.

When the illumination measurement image information is created in this manner, the CPU 13 adds the created illumination measurement image information to the image information subjected to the image processing in the image signal processor 16. By displaying the image on the image display unit 11 using such image information, an image based on the advertising content image information can be displayed on the display area V except for the measurement area V1, and an image based on the illumination measurement image information can be displayed on the measurement area V1.

The brightness detector 12b executes a brightness detection process on a predetermined time interval basis and sends, to the CPU 13, the measurement signal including the measurement result of illumination of outside light received through the window portion Wa and the measurement result of illumination of light emitted from the measurement area V1 received through the window portion Wc. The illumination of light emitted from the measurement area V1 corresponds to the illumination of the panel surface V.

The CPU 13 calculates the average illumination of outside light based on the illumination of outside light in each window portion Wa from the measurement signal sent from the brightness detector 12b. When the average illumination (lx) of outside light and the illumination (lx) of the panel surface V are obtained, the CPU 13 selects the color used in the adjustment process executed by the image signal processor 16, that is, the color assigned to the color display area v.

Specifically, if the average illumination of outside light is lower than predetermined illumination, and the illumination of the panel surface V is lower than predetermined illumination, a blue color group is selected. Meanwhile, if the average illumination of outside light is equal to or higher than the predetermined illumination, or if the illumination of the panel surface V is equal to or higher than the predetermined illumination, a red color group is selected.

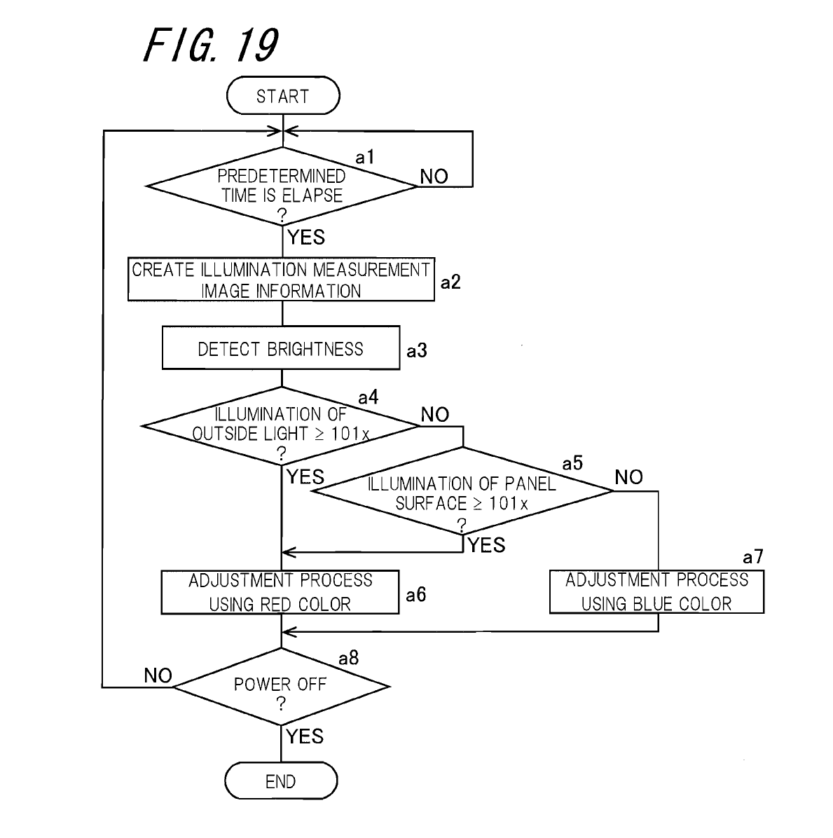

FIG. 19 is a flowchart illustrating a sequence of a display format adjustment process in the digital signage apparatus 1B according to the third embodiment. As power is turned on, the digital signage apparatus 1B is in an operable state. As a result, an image based on the image information subjected to the image processing in the image signal processor 16 is displayed on the image display unit 11.

When the digital signage apparatus 1B is in an operable state as described above, the CPU 13 starts a display format adjustment process, and the process proceeds to step a1. In step a1, the CPU 13 determines whether or not a predetermined time is elapsed. When the CPU 13 determines that a predetermined time is elapsed, the process proceeds to step a2.

In step a2, the CPU 13 creates the illumination measurement image information based on the advertising content image information inputted to the image signal processor 16.

In step a3, the CPU 13 sends a brightness detection process start command to the switching controller 37. As a result, in the brightness detector 12, the illumination of the light received through each window portion Wa and Wc is measured by the illumination sensor 39 for each window portion Wa and Wc in turn.

In step a4, the CPU 13 calculates average illumination of outside light based on illumination of outside light at every window portion Wa measured by the step a3, and determines whether or not the predetermined illumination for average illumination of the calculated outside light. In the embodiment, the predetermined illumination is set to 10 lx. If it is determined that the average illumination of outside light is equal to or higher than 10 lx, the process proceeds to step a6. If it is determined that the average illumination of outside light is lower than 10 lx, the process proceeds to step a5.

In step a5, the CPU 13 determines whether or not illumination of the panel surface V is equal to or higher than predetermined illumination. In the embodiment, the predetermined illumination is set to 10 lx. If it is determined that the illumination of the panel surface V is equal to or higher than 10 lx, the process proceeds to step a6. If it is determined that the illumination of the panel surface V is lower than 10 lx, the process proceeds to step a7.

In step a6, the CPU 13 sends an execution command for the adjustment process as shown in FIGS. 5B and 6B to 6E, to image signal processor 16. At this time, the CPU 13 assigns red color (red group) to the color display area v added by the adjustment process. As a result, image display unit 11 displays an image obtained by adding the red color display area v to the original advertising image to be displayed on the image display unit 11.

In step a7, the CPU 13 sends an execution command for the adjustment process as shown in FIGS. 5B and 6B to 6E, to the image signal processor 16. At this time, the CPU 13 assigns blue color (blue color group) added by the adjustment process to the color display area v. As a result, the image display unit 11 displays an image obtained by adding the blue color display area v to the original advertising image to be displayed on the image display unit 11.

In step a8, the CPU 13 determines whether or not power of the digital signage apparatus 1B is turned off. If it is determined that power is turned off, the CPU 13 terminates the display format adjustment process. If it is determined that power is not turned off, that is, if power is turned on, the CPU 13 returns the process to step a1.

As described above, according to the embodiment, an image obtained by adding the color display area v for displaying colors for attracting attention of people to the original advertising image is displayed on the image display unit 11 of the digital signage apparatus 1B. In the color display area v, a color selected by considering the Purkinje phenomenon is displayed. That is, if the surrounding environment of the digital signage apparatus 1B is dark, a blue color which looks bright in a dark place is displayed. If the surrounding environment of the digital signage apparatus 1B is not dark, a red color is displayed.

In this manner, since a different color is displayed on the color display area v depending on surrounding environment, interests or attention of people who surround the digital signage apparatus 1B can be effectively attracted to the advertising image displayed on the image display unit 11. As a result, it is possible to enhance the advertising effectiveness by improving the attention-grabbing of the advertising image, that is, the attractiveness and the attention value.

Further, according to the embodiment, since the illumination of the panel surface V is actually measured based on the light emitted from the panel surface V, it is possible to obtain more accurate illumination of the panel surface V.

In the embodiment, the color display area v for effectively attracting attention of people who surround the digital signage apparatus 1 to the advertising image displayed on the image display unit 11 is added to the original advertising image to be displayed on the image display unit 11.

However, the embodiment is not limited to such a process, but as shown in FIG. 13, during image switching, an insertion image A3 having a color selected based on the illumination of outside light and the illumination of the panel surface V may be inserted in an interval between display of the advertising images A1 and A2. The digital signage apparatus 1B may be provided with the light-emitting unit 18, and the color display for attracting attention of people may be performed by on/off control of the light-emitting unit 18.

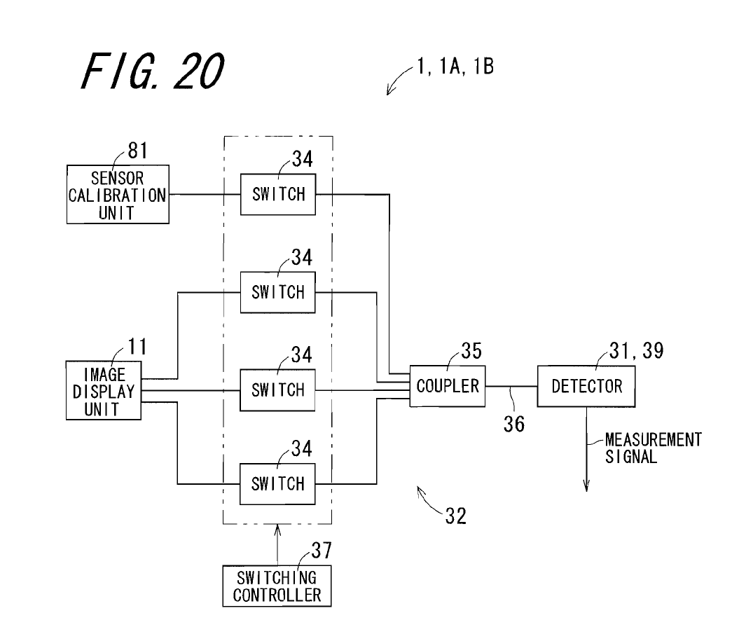

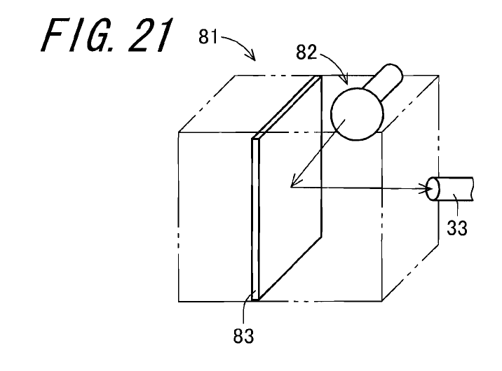

FIG. 20 is a systematic diagram schematically illustrating the digital signage apparatus 1, 1A, and 1B further including a sensor calibration unit 81. FIG. 21 is a perspective view schematically illustrating a configuration of the sensor calibration unit 81.

As shown in FIG. 20, it is preferable that the digital signage apparatus 1, 1A, and 1B further includes a sensor calibration unit 81 for calibrating the detector for detecting brightness (a spectral radiance sensor 31 or the illumination sensor 39).

The sensor calibration unit 81 includes a reference light source 82 and a reference white board 83. The sensor calibration unit 81 is configured to irradiate the reference white board 83 with light using the reference light source 82 and introduce the reflection light from the reference white board 83 into the first optical fiber 33.

The white dot and black dot of the spectral radiance sensor 31 or the illumination sensor 39 can be corrected by providing the sensor calibration unit 81. The correction of white dot is carried out by inputting the light from the reference light source 82, reflected at the reference white board 83, into the spectral radiance sensor 31 or illumination sensor 39. The correction of black dot is carried out by cutting off the optical transmission channel of the first optical fiber 33 using the switch 34 based on an output value caused by the dark current of the spectral radiance sensor 31 or the illumination sensor 39.

This technology may be embodied in a computer readable recording medium storing a program, when executed in a computer, capable of implementing a method of controlling digital signage apparatuses 1, 1A, and 1B by considering the Purkinje phenomenon based on the measurement result of illumination or spectral radiance of outside light measured by the brightness detector 12, spectral radiance of light emitted from the backlight 22 and illumination of light emitted from the measurement area V1 in the display screen V.

As a result, a recording medium on which are recorded program codes for carrying out the aforementioned processes (including an execution format program, an intermediate code program, and a source program) can be provided in a portable manner.

Note that, in the embodiment, in order to carry out processes with a microcomputer, as the recording medium, a memory (not shown) itself such as a ROM may be used for a program medium. Alternatively, the recording medium may be a program medium readable by inserting the recording medium into a program reader provided as an external storage device (not shown).

In any case, a stored program may be executed by a microprocessor accessing the program, or in any case, a scheme may be employed in which a program code is read, the read program code is downloaded into a program storage area (not shown) of a microcomputer, and the program is executed. The program for download is stored in advance in a main body apparatus.

Here, the above program medium is a recording medium configured to be separable from a main body, and may be a medium that fixedly carries a program code thereon, including a tape type, such as a magnetic tape or cassette tape, a disk type including a magnetic disk such as a flexible disk or hard disk or an optical disk such as CD-ROM/MO/MD/DVD, a card type, such as an IC card (including a memory card)/optical card, or a semiconductor memory such as a mask ROM, EPROM (Erasable Programmable Read Only Memory), EEPROM (Electrically Erasable Programmable Read Only Memory), or flash ROM.

Further, by providing a system configuration capable of connecting a communication network including the Internet, the program medium may be a medium that carries thereon a program code such that a program code is downloaded from the communication network in a streaming manner. Note that when a program code is thus downloaded from the communication network, the program for download may be stored in advance in a main body apparatus or may be installed from another recording medium. Note also that the technology can also be implemented in the form of a computer data signal in which the above program code is embodied by electronic transmission and which is embedded in a carrier wave.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. A digital signage apparatus comprising:
an image display unit capable of displaying an image;
a display format adjuster that displays an image on the image display unit in a predetermined display format; and
a controller that selects a color depending on brightness of outside light surrounding the image display unit and brightness of a display area on the image display unit and controls the display format adjuster such that an image is displayed on the image display unit in a predetermined display format depending on the color selected by the controller.

2. The digital signage apparatus of claim 1, wherein the display format adjuster forces the image display unit to display an image provided with a color display area for displaying the color selected by the controller, in a peripheral area of an original image to be displayed on the image display unit, and
the controller controls the display format adjuster such that the color selected by the controller is displayed on the color display area.

3. The digital signage apparatus of claim 1, wherein in a case where a text image is included in an original image to be displayed on the image display unit, the display format adjuster forces the image display unit to display an image provided with an area for applying one of an underline, a box, a highlight, and a shading, as a color display area for displaying the color selected by the controller in a peripheral area of the text image, and
the controller controls the display format adjuster such that the color selected by the controller is displayed on the color display area.

4. The digital signage apparatus of claim 1, wherein in a case where display of one image on a display area is followed by display of another image, the display format adjuster forces the image display unit to display, the image obtained by using the color selected by the controller in an interval between the display of the one image and the display of the other image.

5. The digital signage apparatus of claim 1, wherein the controller selects a blue color in a case where both brightness of outside light and brightness of the display area are darker than a predetermined brightness, and a red color in a case where brightness of outside light and/or brightness of display area are equal to or brighter than a predetermined brightness.

6. The digital signage apparatus of claim 5, further comprising a spectral radiance sensor that measures spectral radiance,
wherein the image display unit includes a display panel on which an image is to be displayed and a backlight that emits light from a back side in the display panel, and
the controller calculates illumination of the display area based on spectral radiance of light emitted from backlight which is measured by the spectral radiance sensor.

7. The digital signage apparatus of claim 6, wherein the controller calculates illumination of the display area based on spectral radiance of light emitted from the backlight which is measured by the spectral radiance sensor, spectral transmittance of members constituting the image display unit, and image information of an original image to be displayed on the image display unit.

8. The digital signage apparatus of claim 5, further comprising an illumination sensor that measures illumination of light emitted from the predetermined area for measurement on the image display area,
wherein for the measurement area, the controller obtains illumination of a display area using the illumination sensor by displaying an image corresponding to a maximum pixel value or average pixel value in an original image to be displayed.

9. A digital signage apparatus comprising:
an image display unit capable of displaying an image;
a light-emitting unit disposed in a vicinity of an image display area in an image display unit, the light-emitting unit having a light source capable of emitting light of a plurality of predetermined colors; and
a controller that selects a color depending on brightness of outside light in a vicinity of the image display unit and brightness of a display area in the image display unit and controls turn-on of the light source in the light-emitting unit such that light of the color selected by the controller is emitted.

10. The digital signage apparatus of claim 9, wherein the controller selects a blue color in a case where both brightness of outside light and brightness of the display area are darker than a predetermined brightness, and a red color in a case where brightness of outside light and/or brightness of display area are equal to or brighter than a predetermined brightness.

11. The digital signage apparatus of claim 10, further comprising a spectral radiance sensor that measures spectral radiance,
wherein the image display unit includes a display panel on which an image is to be displayed and a backlight that emits light from a back side in the display panel, and
the controller calculates illumination of the display area based on spectral radiance of light emitted from backlight which is measured by the spectral radiance sensor.

12. The digital signage apparatus of claim 11, wherein the controller calculates illumination of the display area based on spectral radiance of light emitted from the backlight which is measured by the spectral radiance sensor, spectral transmittance of members constituting the image display unit, and image information of an original image to be displayed on the image display unit.

13. The digital signage apparatus of claim 10, further comprising an illumination sensor that measures illumination of light emitted from the predetermined area for measurement on the image display area,
wherein, for the measurement area, the controller obtains illumination of a display area using the illumination sensor by displaying an image corresponding to a maximum pixel value or average pixel value in an original image to be displayed.

14. A non-transitory computer readable recording medium on which a program is recorded that causes a computer to execute the steps of:
determining whether or not brightness of outside light and brightness of a display area are darker than a predetermined brightness;
selecting a blue color when it is determined that both the brightness of outside light and the brightness of the display area are darker than the predetermined brightness, and selecting a red color when it is determined that brightness of outside light and/or brightness of the display area are equal to or brighter than the predetermined brightness; and
displaying an image in a predetermined display format depending on the selected color.

15. A method of adjusting a display format comprising the steps of:
determining, by a controller, whether or not brightness of outside light and brightness of a display area, which are detected by a brightness detector, are darker than a predetermined brightness;
selecting, by the controller, a blue color when it is determined that both the brightness of outside light and the brightness of the display area are darker than the predetermined brightness, and selecting, by the controller, a red color when it is determined that brightness of outside light and/or brightness of the display area are equal to or brighter than the predetermined brightness; and
forcing, by a display format adjuster, an image display unit to display an image in a predetermined display format depending on the color selected by the controller.
